(19) United States
(12) Patent Application Publication
(10) Pub. No.: US 2008/0253242 A1
(43) Pub. Date: Oct. 16, 2008

(54) Information recording medium, recording method of information recording medium, and information recording and reproducing device

(75) Inventors: Masatsugu Ogawa, Tokyo (JP); Naoki Suzuki, Tokyo (JP); Minoru Akiyama, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/889,514

(22) Filed: Aug. 14, 2007

(30) Foreign Application Priority Data
Aug. 15, 2006 (JP) 2006-221666

(51) Int. Cl. G11B 5/09

(52) U.S. Cl. 369/47.1

(57) ABSTRACT

A information recording medium includes a data area and a system area. In the data area, a user data is recorded. In the system area, management information for managing a recording status of the data area is recorded. The management information recorded in the system area includes recording mode information which indicates a recording procedure of the user data in the data area. By this construction, an information recording medium, a recording method of an information recording medium and an information recording and reproducing medium which are able to appropriately treat an information recording medium having an availability to a plurality of recording mode when being loaded.

### BACKGROUND ART

1. Field of the Invention

The present invention relates to a recording method of high density optical discs and a recording and reproducing device thereof.

2. Description of Related Art

As standards of DVD (Digital Versatile Disc), there exist four main types of DVD-ROM (DVD-Read Only Memory), DVD-R (DVD-Recordable), DVD-RW (DVD-Rewritable), and DVD-RAM (DVD-Random Access Memory). Of them, three types of the DVD-R, the DVD-RW, and the DVD-RAM are standards of a recordable type, and these standards have very different characteristics in their recording manners (recording modes).

The DVD-R and the DVD-RW are standards considering compatibility with the DVD-ROM, and user data are basically recorded sequentially in continuous areas (a sequentially recording mode). Specifically, in the sequentially recording mode, new user data are recorded by continuously adding the data into previously recorded area, thus, completely recorded areas increase. The writing manner is implemented based on a reason why many DVD players (apparatuses only for reproduction having only reproduction function) have a characteristic which does not allow an access to an area with no recording mark. That is to say, areas which the DVD players can access must be fully filled with the recording marks. Many DVD players employ a DPD system which realizes a servo by calculating tracking error signals from data signals as s tracking system. The DVD player employing the DPD system cannot access the areas with no recording mark.

As a tracking system, there also exists a push-pull system which can realize a tracking with a guide groove. Although the push-pull system can realize an access to an unrecorded area, a cost goes up. As a result, most of the DVD players do not employ this system.

Meanwhile, the sequential recording is suitable for a usage for recording and reproducing DVD videos, that is, a DVD player and a DVD recorder. In addition, the DVD-R and the DVD-RW employ a physical format with a high compatibility with the DVD-RW in order to allow reproduction by DVD players.

The DVD-RAM values recording and reproducing text data and application data by information processing apparatuses such as a personal computer compared to reproducing by the DVD players. Accordingly, there is relatively small need to pay attention to reproduction by DVD players, and there is no necessity to employ the sequential recording system suitable for the DVD players. Employment of a random recording system convenient for recording text data and application data by personal computers and the like is rather rational. Consequently, the DVD-RAM employs the random recording system that allows recording into arbitrary parts in a user data area, like a hard disc drive installed in a personal computer and the like. Hereby, usability of the DVD-RAM in information processing apparatuses is much better than that of the DVD-R and the DVD-RW. However, parts recording user data and unrecorded parts randomly exist on a same disc until user data are recorded into all recording areas because the random recording system allows recording into an arbitrary part in a disc. Therefore, reproduction by a DVD player cannot be realized.

Some of related arts are exemplified below. Japanese Laid-Open Patent Application (JP-P2005-190539A) discloses a technique regarding management information showing recording status in a random recording mode or a sequential recording mode.

Japanese Laid-Open Patent Application (JP-P2006-514390A) discloses a recording method and recording apparatus for an optical recording medium. In this document, management information is recorded in a management area of an optical recording medium. The management information includes a recording status information indicating whether a specific area of the optical recording medium is recorded or not, and update information indicating whether the recording status information is continuously managed or not.

Japanese Laid-Open Patent Application (JP-A-Heisei, 9-265630) discloses a recording and reproducing apparatus for a recording medium. In the technique of this document, dummy data is recorded for controlling an optical disc correctly even when data is intermittently recorded.

Japanese Laid-Open Patent Application (JP-P2005-32413A) discloses a recording method of an optical disc for recording data on an indicated address area even when unrecorded area exist in ahead of the indicated address area.

### SUMMARY

As described above, a medium which provides compatibility with a medium only for reproduction (DVD-ROM: ROM medium) and allows the random recording does not exist in the present DVD standard. Thus, it is required to change a recording medium depending on a usage of such as video recording or data file recording. For users, it is preferable that one recording medium is able to be used for both of the sequential recording and the random recording.

In a case where one recording medium is used for both of the sequential recording and the random recording, there is no problem when a recording apparatus supports both of the recording modes. However, in a case where the recording apparatus supports only either one of the modes, handling may be impossible when a recording medium recorded in unsupported recording medium is loaded.

An exemplary object of the present invention is to provide an information recording medium, a recording method of information recoding medium, and an information recording and reproducing device, which allow handling a medium when the recording medium that can be used in a plurality of recording modes is loaded.

Another exemplary object of the present invention is to provide a recording method of information recoding medium, and an information recording and reproducing device, which produces an information recording medium that can be reproduced by an apparatus only for reproduction without making users aware of the modes.

According to an exemplary aspect of the invention, an information recording medium includes: a data area which records user data; and a system area which records management information to manage a recording status of the data area. The management information includes a recording mode information indicating a recording procedure of the user data stored in the data area.

According to another exemplary aspect of the invention, a recording method of an information recording medium includes: (a) reading out recording mode information from an information recording medium, wherein the recording mode information is set to the information recording medium and indicates a recording procedure of a user data storing in the information recording medium; (b)judging whether a recording function corresponding to the recording procedure indicated by the recording mode information is available or not; and (c) recording data to the information recording medium when the recording function is judged to be available in the (b) judging or executing rejection operation indicating data recording to the information recording medium being not possible when the recording function is judged to be not available in the (b) judging.

According to further another exemplary aspect of the present invention, an information recording and reproducing apparatus includes: a recording status information read unit configured to read recording mode information from an information recording medium, wherein the recording mode information shows a recording mode indicating a recording procedure of a user data to be recorded in the information recording medium and is set to the information recording medium; and a processing determination unit configured to judge whether a recording function corresponding to the recording procedure indicated by the recording mode information is available or not. Data recording on the information recording medium is performed only when the processing determination unit judges the recording function is available, or the information recording and reproducing apparatus performs a rejection operation which shows data recording to the information recording medium is not possible when the processing determination unit judges the recording function is not available.

According to the present invention, an information recording medium, a recording method of information recoding medium, and an information recording and reproducing device, which allow handling a medium when the information recording medium that can be used in a plurality of recording modes is loaded can be provided.

According to the present invention, a recording method of information recoding medium, and an information recording and reproducing device, which produce an information recording medium that can be reproduced by an apparatus only for reproduction without making users aware of the modes can be provided.

### BRIEF DESCRIPTION OF THE DRAWINGS

FIG. 1 is a block diagram showing a configuration of an information recording and reproducing device according to embodiments of the present invention;

FIG. 2 is a view showing an example of management information thereof;

FIG. 3 is a flowchart showing a schematic operation of an optical disc device according to a first embodiment of the present invention;

FIG. 4 is a view explaining a recording status of the optical disc thereof;

FIG. 5 is a view explaining a recording status of dummy data of the optical disc thereof;

FIG. 6 is a flowchart showing details of an operation of the optical disc device thereof;

FIG. 7A is a flowchart (1) of the random recording mode processing thereof;

FIG. 7B is a flowchart (2) of the random recording mode processing thereof;

FIG. 8A is a flowchart (1) of a dummy data recording processing 1 thereof;

FIG. 8B is a flowchart (2) of the dummy data recording processing 1 thereof;

FIG. 9 is a view showing an example of area division when the dummy data recording thereof is executed;

FIG. 10 is a flowchart of a dummy data recording processing 2 thereof;

FIG. 11 is a view showing an example of area division when the dummy data recording thereof is executed;

FIG. 12 is a flowchart of host command reception processing thereof;

FIG. 13 is a flowchart showing a schematic operation of an optical disc device according to a second embodiment of the present invention;

FIG. 14 is a flowchart showing details of an operation of the optical disc device thereof; and

FIG. 15 is a flowchart of a sequential recording mode processing thereof.

### EXEMPLARY EMBODIMENTS

Referring to accompanying drawings, exemplary embodiments for carrying out the invention will be described.

### First Embodiment

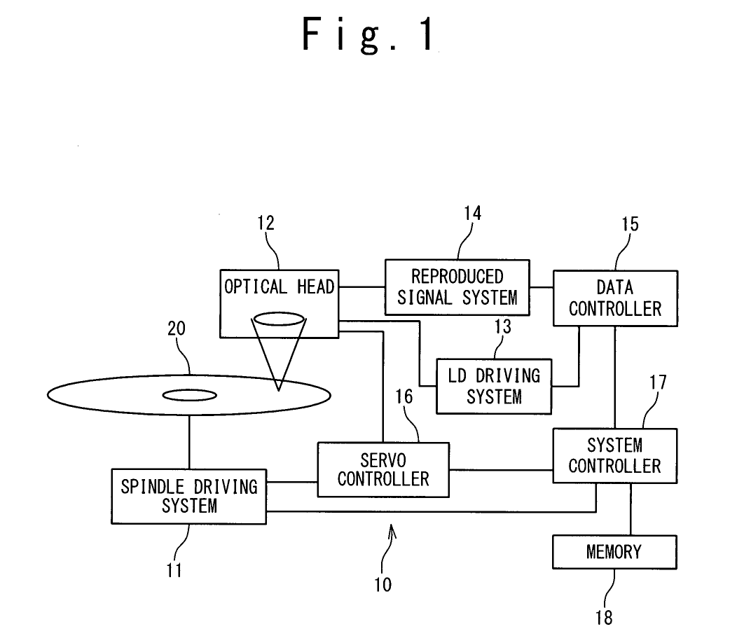

FIG. 1 is a block diagram showing a configuration of an information recording and reproducing device (referred to as an optical disc device below) according to a first embodiment of the present invention. An optical disc driving device 10 includes a spindle driving system 11, an optical head 12, an LD driving system 13, a signal reproduction system 14, a data controller 15, a system controller 17, a memory 18, and a servo controller 16.

The spindle driving system 11 drives an optical disc 20. The optical head 12 includes a laser diode (LD), a beam splitter, an objective lens, and an optical receiver, and emits laser to the optical disc 20 to detect its reflected light. The detected inputted signal is outputted to the signal reproduction system 14. The LD driving system 13 drives the laser diode of the optical head 12. The signal reproduction system 14 executes processing such as filtering to a signal inputted from the optical head 12.

The data controller 15 outputs a signal inputted from the signal reproduction system 14 to a system controller 17 after demodulating the signal and outputs a signal inputted from the system controller 17 to the LD driving system 13 after modulating the recorded data. The servo controller 16 generates a servo signal and controls a position and a trim of the optical head 12.

The system controller 17 takes the demodulated data from the data controller 15 and outputs data to be recorded to the optical disc 20 to the data controller 15. The system controller 17 controls the spindle driving system 11 and the servo controller 16 and controls the optical disc driving device 10 overall. The system controller 17 records these control information into the memory 18 and uses them for control. The system controller 17 controls the data controller 15, the servo controller 16 and the like and reads information regarding a data recording status of the optical disc 20 from a management information area of the optical disc 20 to record them into the memory 18. The system controller 17 includes a recording status information reading part, a processing determination part, and a dummy data recording process controlling part in inside and executes dummy data recording processing to an unrecorded area by using regarding a data recording status of the optical disc 20.

The optical disc 20 is a medium of an in-groove format whose data bit length is 0.15 μm and whose track pitch is 0.40 μm. An information management area called RMZ (Recording management zone) is arranged on inner side (a side placed nearer to the center of an optical disc) of the optical disc 20. Information such as a recording status is recorded in the area and the optical disc driving device 10 manages a recording status of the optical disc 20 based on this information. Various kinds of information can be recorded in the RMZ in principle. Specifically, information recorded in the RMZ includes recording mode information and data recording log (which is data showing a recording history). The recording mode information shows information regarding a recording mode (which shows a recording procedure) and the data recording log shows information regarding unrecorded areas on the optical disc 20.

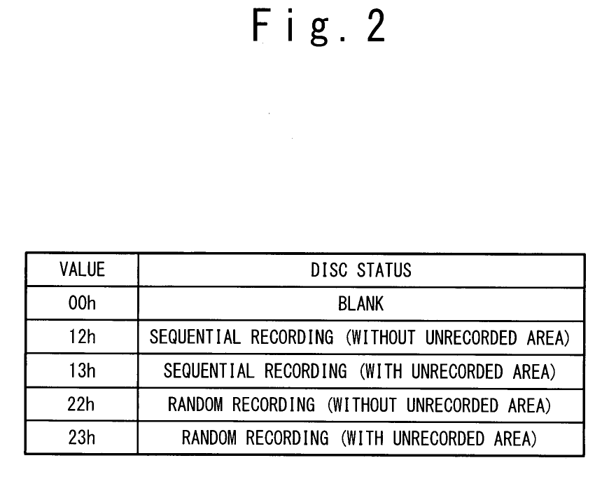

In the present embodiment, an area of 1 bite is kept in the RMZ and the recording mode information is recorded in the area. As shown in FIG. 2, the recording mode information shows a sequential recording mode or a random recording mode and the existence or no-existence of unrecorded area by representing corresponding numeric value. Specifically, a blank disc (a disc in which no user data is recorded yet) is shown by a value of 00 h (the h indicates hexadecimal), the sequential recording mode disc with no-existence of unrecorded area is shown by a value of 12 h, the sequential recording mode disc with remaining unrecorded area is shown by a value of 13 h, the random recording mode disc with no-existence of unrecorded area is shown by a value of 22 h, and the random recording mode disc with remaining unrecorded area is shown by a value of 23 h. The optical disc driving device 10 is able to recognize a present condition of the optical disc 20 by reading the information from the optical disc 20. Accordingly, the optical disc driving device 10 is able to execute operations suitable for the optical disc 20 to a plurality of recording modes by reading the management information. Even if a user loads the optical disc 20 to which the optical disc driving device 10 does not support an operation in the optical disc driving device 10 by mistake, the optical disc driving device 10 can handle a case appropriately by indicating error or the like.

Next, an operation of the optical disc driving device 10 will be described. The operation differs depending on a mode that the optical disc driving device 10 supports, the sequential recording mode or the random recording mode. The optical disc driving device 10 according to a first embodiment operates for only the random recording mode.

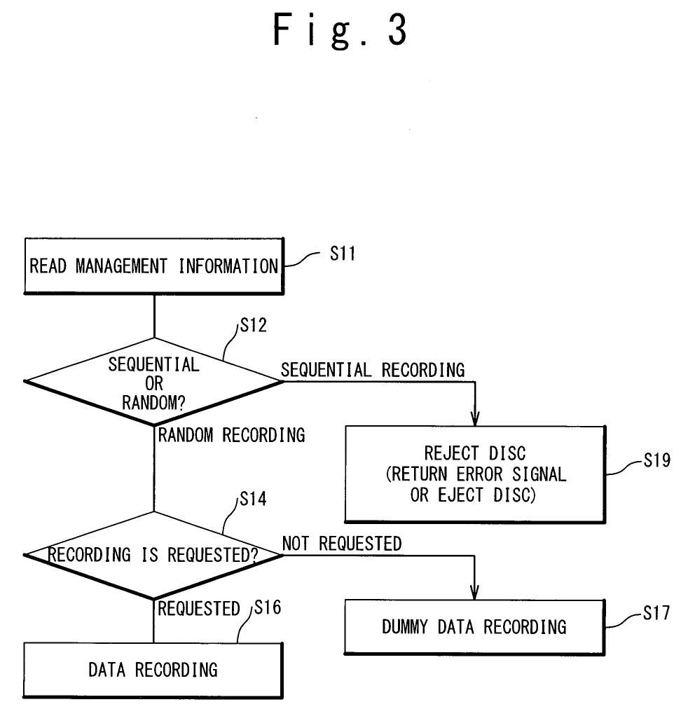

The optical disc driving device 10 for only the random recording mode operates as shown in FIG. 3 responding to an indication from a host device. The optical disc driving device 10 accesses an information management area of the loaded optical disc 20, and reads the management information (step S11). The optical disc driving device 10 determines which recording mode does the optical disc 20 record data in based on the recording mode information in the management information (step S12).

When the optical disc 20 is recorded in the sequential recording mode (step S12 in the case of sequential recording), the optical disc driving device 10 cannot allow recording operation in the sequential recording mode since supporting only the random recording mode. As a result, the optical disc driving device 10 executes a recording refusal operation, such as returning error signal to an indication of the host device or ejecting the loaded optical disc 20, without executing recording even when the host device demands recording.

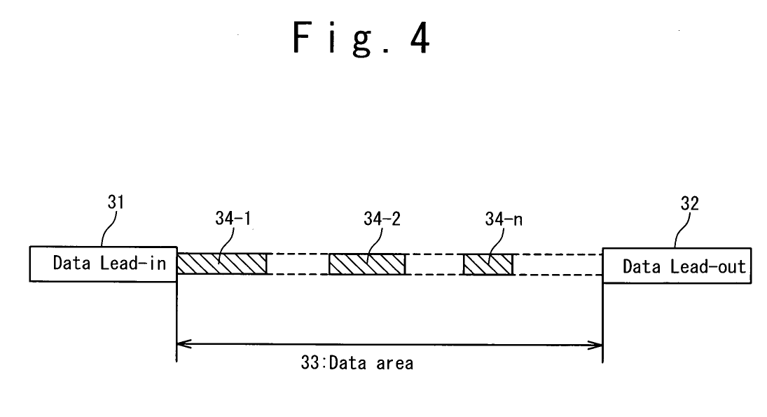

On the other hand, when the optical disc is recorded in the random recording mode (step S12 in the case of random recording), the optical disc driving device 10, when the host device demands recording (step S14 in the case of demanded), executes recording in accordance with the demand for recording (step S16). As shown in FIG. 4, the optical disc 20 generally includes a lead-in area 31, a data area 33, and a lead-out area 32. Management information and the like are recorded in the lead-in area 31 which is a system area, and user data is recorded in the data area 33. As shown in FIG. 4, a recorded area 34 in which user data is recorded scatter in the data areas 33, 34-1, 34-2, . . . , 34-n. As described above, when the recorded areas and the unrecorded areas are exist in mixed, the optical disc is considered as an optical disc which cannot be reproduced by an apparatus only for reproduction which cannot access the unrecorded areas.

When the host device does not demand recording (step S14 not demanded), the optical disc driving device 10 of a first embodiment executes dummy data recording processing for recording dummy data into the unrecorded areas (step S17). The dummy data recording processing is a process for retaining compatibility with a ROM medium, and the optical disc driving device 10 automatically records recording marks in the unrecorded areas. When recording marks are formed on whole areas of the optical disc 20 or when the dummy data recording processing completes forming recording marks in all areas, dummy data is not recorded obviously because of lack of necessity of recording more. Information whether an unrecorded area remains in the optical disc 20 or not is recorded in the optical disc 20 as the data recording log.

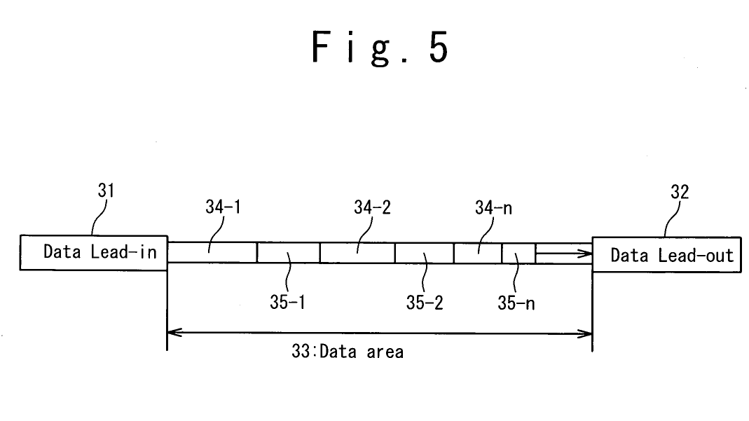

As shown in FIG. 5, when all of scattering unrecorded areas are changed to recorded areas 35-1, 35-2, . . . , 35-n by the dummy data recording, compatibility with the ROM medium is secured and the optical disc 20 can be accessed by the apparatus only for reproduction.

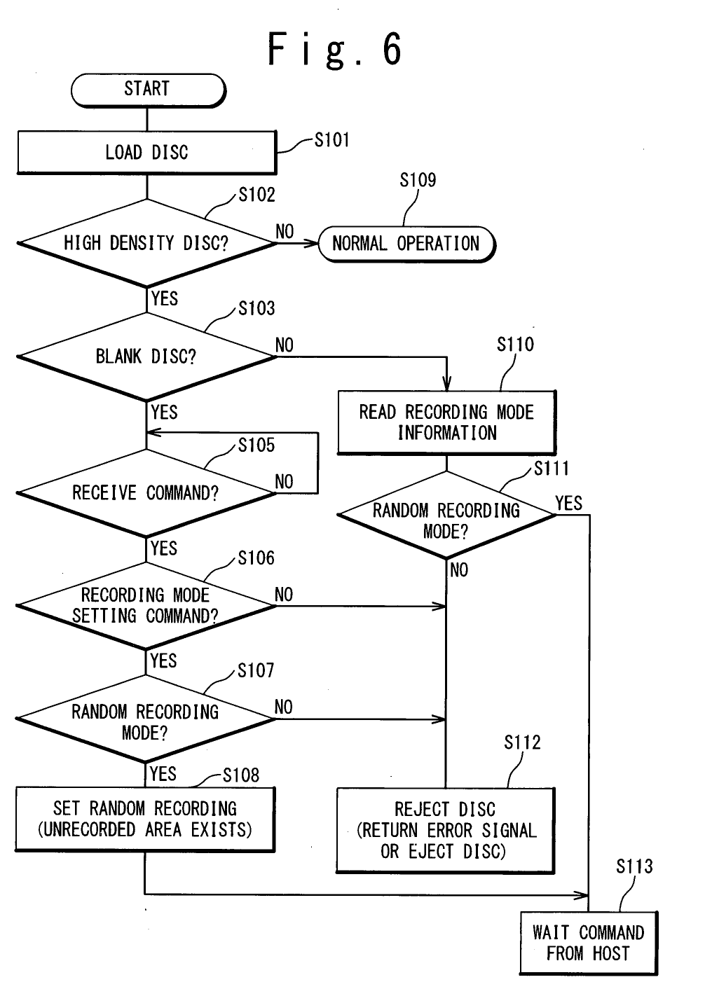

Further, referring to FIGS. 6 to 12, details of an operation of the optical disc driving device 10 will be described. FIG. 6 is a flow chart showing an operation when the optical disc 20 is loaded in the optical disc driving device 10.

When the optical disc 20 is loaded, the optical disc driving device 10 starts driving of the optical disc 20 according to a predetermined procedure including, for example, spindle on, laser on, and servo on. When the optical disc 20 is set to be accessible, the optical disc driving device 10 reads management information recorded in the system area. A sort of the optical disc and a data recording status are specified based on a distance from an optical disc surface to a reflecting film, the number of the reflecting films, and other information recorded in the optical disc 20 (step S101).

When the loaded optical disc 20 is not a high density optical disc (step S102 No), processing is progressed to a normal random recording operation without executing setting of recording mode and dummy data recording processing to the recording mode information in the RMZ (step S109). As optical discs with not a high density, a conventional DVD optical disc and a CD optical disc are shown as examples, and as a high density optical disc, an optical disc on which management information of the present embodiment is recorded is assumed.

When the loaded optical disc 20 is the high density optical disc (step S102 Yes), the optical disc driving device 10 confirms a recording status of data on the optical disc 20, whether the disc is a blank disc in which user data is not recorded or not (step S103).

When the loaded optical disc 20 is not a blank disc (step S103 No), the optical disc driving device 10 reads recording mode information configured in the RMZ, and confirms the configured information (step S110). When the random recording mode is not set in the recording mode information (step S111 No), error processing such as returning error to the host device and ejecting the disc is executed (step S112). When a set recording mode is the random recording mode (step S111 Yes), a command waiting condition for waiting indication from the host device is set (step S113).

When the loaded optical disc 20 is a blank disc (step S103 Yes), a command waiting condition for waiting indication from the host device is set (step S105).

When a command received from the host device is not a recording mode setting command for setting a recording mode (step S106 No), the optical disc driving device 10 executes error processing such as returning error to the host device and ejecting the disc (step S112). When receiving the recording mode setting command from the host device (step S106 Yes), the optical disc driving device 10 confirms whether a recording mode required by the host device is the random recording mode or not (step S107).

When the recording mode requested by the host device is not the random recording mode (step S107 No), the optical disc driving device 10 executes error processing such as returning error to the host device and ejecting the disc (step S112). When setting of the random recording mode is requested by the host device (step S107 Yes), the “random recording mode (existence of the unrecorded area)” is set as recording mode information and is recorded in the RMZ (step S108). After that, the optical disc driving device 10 is set to be in a condition waiting for a command from the host device (step S113).

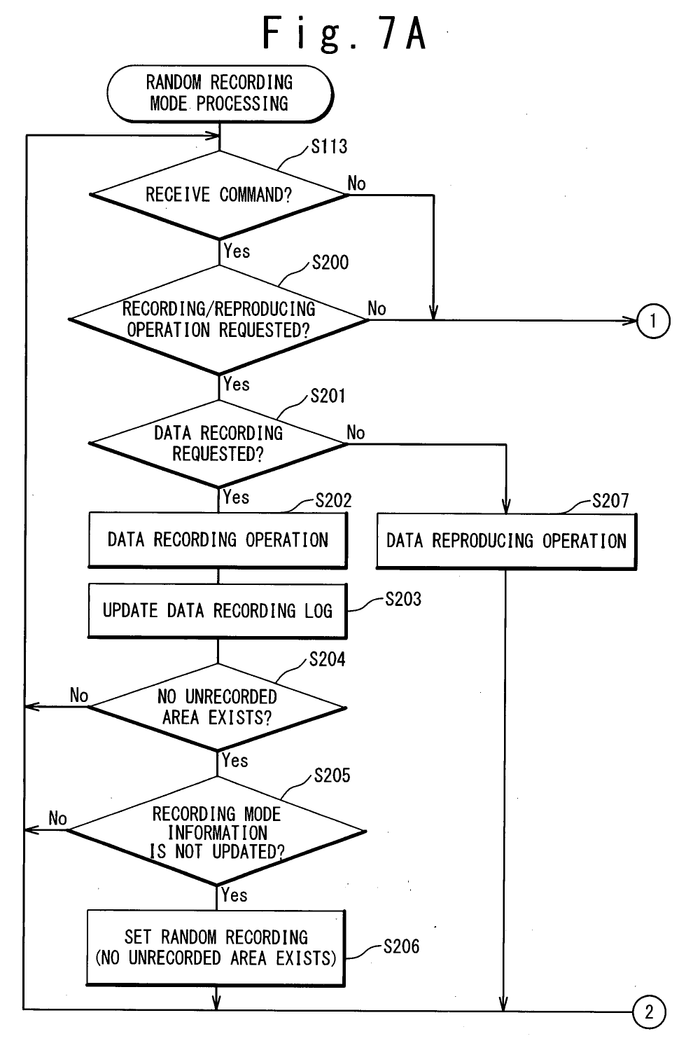

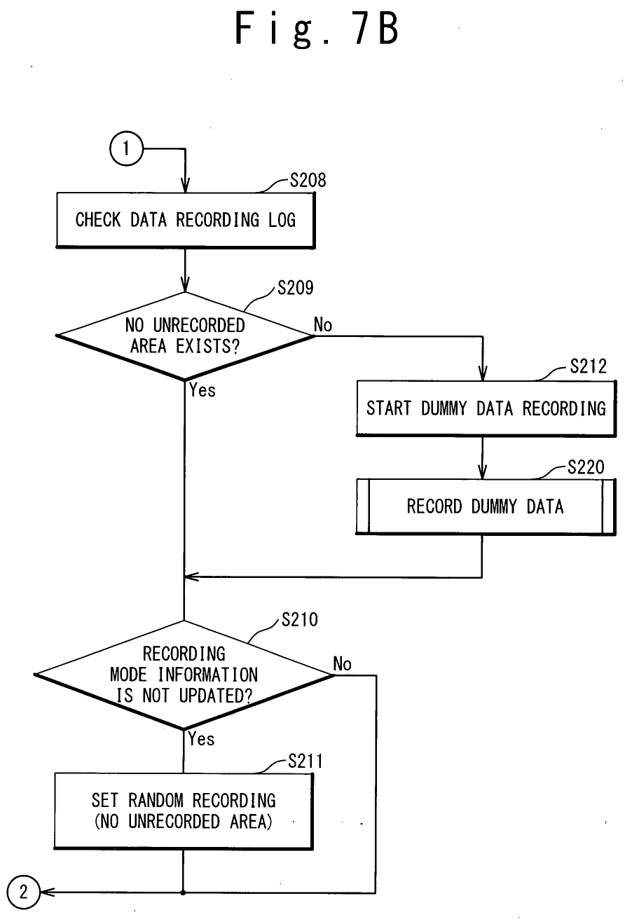

An example of an operation after the command waiting condition (step S113) is sown in FIGS. 7A and 7B. The optical disc driving device 10 waits for indication from the host device in the random recording mode (step S113). When a command requesting a normal recording and reproducing operation is not received from the host device (step S 113 No, step S200 No), a data recording status to the optical disc 20 is confirmed by the data recording log in the RMZ (FIG. 7B: step S208). When an unrecorded area exists on the optical disc 20 (step S209 No), the optical disc driving device 10 automatically starts recording of dummy data to an unrecorded area on the optical disc 20 (step S212). Details of the recording operation of the dummy data (step S220) will be described below.

When an unrecorded area does not exist on the optical disc 20 (step S209 Yes) and when dummy data recording processing (step S220) is completed, it is confirmed whether updating of recording mode information in the RMZ and the data recording log is completed or not (step S210). When the recording mode information and the data recording log are updated (step S210 No), returning to the condition waiting for command from the host device again (FIG. 7A: step S113). When the recording mode information in the RMZ and the data recording log are not updated (step S210—Yes), the random recording mode is set as the recording mode information and no existence of unrecorded area is set as the data recording log (step S211). After that, returning to the condition waiting for a command from the host device again (FIG. 7A: step S113).

Meanwhile, when the command requesting a normal recording and reproducing operation is received (step S200 Yes) in a condition waiting for a command from the host device (FIG. 7A: step S113), contents of the received command are confirmed (step S201).

When the command from the host device is a command for requesting data reproduction (step S201 No), a normal data reproducing operation is executed to the optical disc 20 (step S207), returning to the condition waiting for the command from the host device (step S113). When the command from the host device is a command for requesting data recording (step S201 Yes), a data recording operation is executed to the optical disc 20 (step S202). When data recording is completed, the data recording log in the RMZ showing recording status of data on the optical disc 20 is updated (step S203).

After that, it is determined whether the unrecorded area exists on the optical disc 20 or not (step S 204). When the unrecorded area exists on the optical disc 20 (step S204 No), returning to the condition waiting for the command from the host device (step S113). When the unrecorded area does not exist on the optical disc 20 (step S204 Yes), it is confirmed whether updating of the recording mode information in the RMZ is completed or not (step S205). When the recording mode information in the RMZ is updated (step S205 No), returning to the condition waiting for the command from the host device (step S113). When the recording mode information in the RMZ is not updated (step S205 Yes), the “random recording mode (no existence of unrecorded area)” is set to the recording mode information in the RMZ (step S206), and returning to the condition waiting for the command from the host device (step S113).

Next, details of an operation of dummy data recording processing will be described. The dummy data recording processing is processing for recording dummy data to the unrecorded area on the optical disc 20 when the optical disc driving device 10 does not receive a command requesting a normal recording and reproducing operation. Here, two types of operations will be explained.

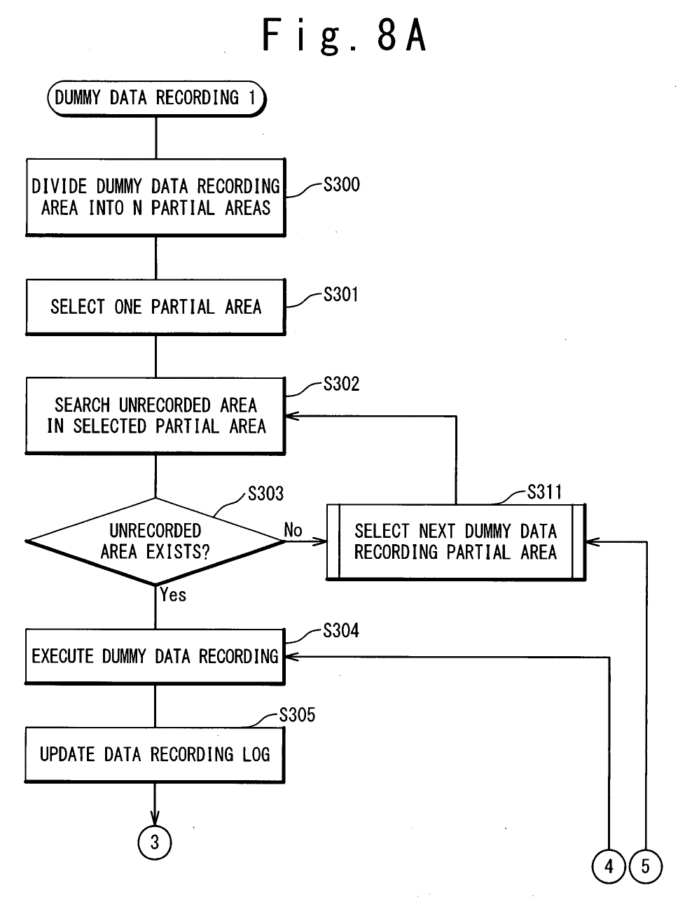

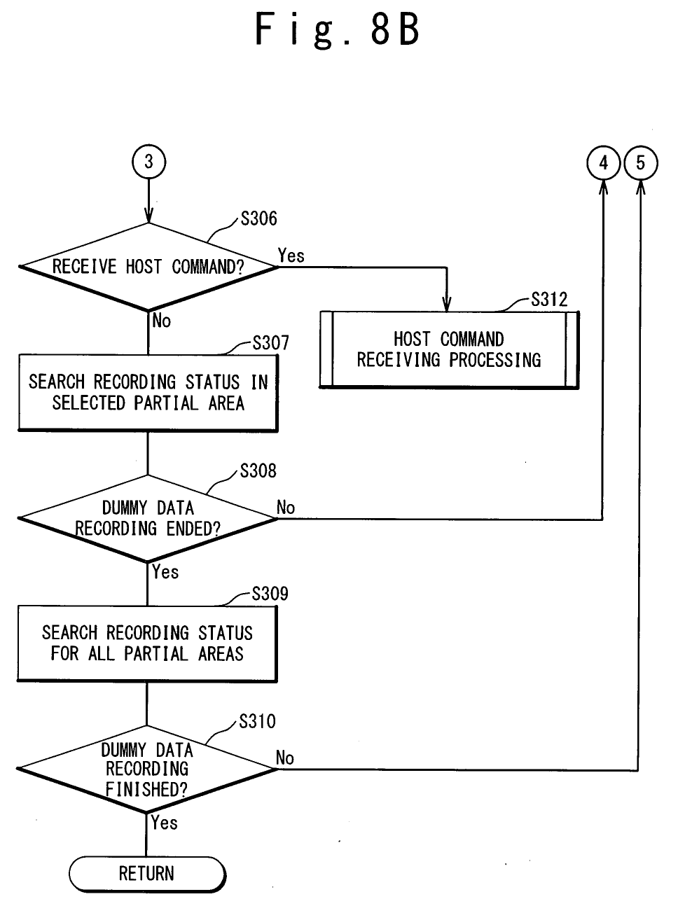

A first operation of dummy data recording processing will be described referring to FIGS. 8A and 8B. In the first dummy data recording processing, when the optical disc driving device 10 records dummy data to an unrecorded area on the optical disc 20, the dummy data recording is executed by allocating a dummy data recording area created by dividing an area in which dummy data must be recorded in a plurality of areas.

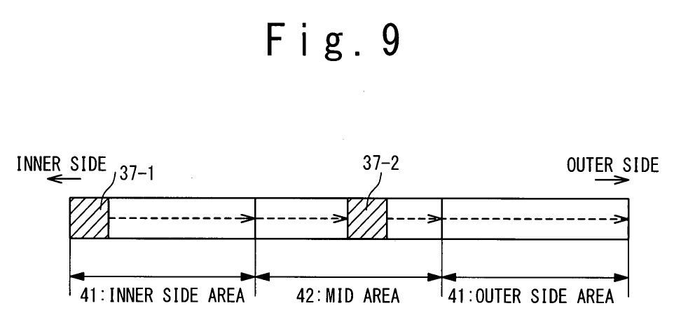

As shown in FIG. 8A, the optical disc driving device 10 divides an area in which dummy data is recorded in a plurality of partial areas (step S300). For example, as shown in FIG. 9, the optical device 10 divides a data area equally into three parts, and divides the area into an inner side area 41, a mid area 42, and an outer side area 43. In the inner side area 41, disc management information of the optical disc 20 is recorded, and a frequency of request for recording from the host device is comparatively high. Accordingly, the optical disc driving device 10 selects a partial area for dummy data recording so that dummy data can be recorded in the order of the outer side area 43 in which frequency of request for recording from the host device is comparatively low, the mid area 42, and the inner side area 41. By selecting a partial area as described above, recording of dummy data can be executed efficiently on the optical disc 20. As a result, the optical disc driving device 10 selects the outer side area 43 as an area in which dummy data is recorded at first (step S301).

When an area in which dummy data is recorded is set, the optical disc driving device 10 searches existence of an unrecorded area in a selected dummy data recording area (step S302). When an unrecorded area does not exist in the selected dummy data recording area (step S303 No), the optical disc driving device 10 selects next dummy data recording area (step S311),and searches existence of an unrecorded area in the dummy data recording area (step S302).

When the unrecorded area exists in the selected dummy data recording area (step S303 Yes), the optical disc driving device 10 executes recording of dummy data to the unrecorded area (step S304). As shown in FIG. 9, when a recorded area 37-1 exists in the inner side area 41, an unrecorded area in the inner side area 41 exists as one area not including the recorded area 37-1. A recorded area 37-2 exists in the mid area 42, and an unrecorded area in the mid area 42 is divided into 2 areas by the recorded area 37-2. In such a case, an unrecorded area on an outer side is selected at first, for example, and the dummy data is recorded. When the dummy data is recorded in the unrecorded area, the data recording log in the RMZ showing a recording status of data on the optical disc 20 is updated (step S305). After that, it is confirmed whether a command is received from the host device or not (FIG. 8B: step S306).

When a command is received from the host device (step S306 Yes), host command reception processing starts (step S312). Details of the host command reception processing will be described below. When the command is not received from the host device (step S306 No), searching of completion of dummy data recording to the selected dummy data recording partial area is executed based on the data recording log (step S307). When the dummy data recording to the selected dummy data recording partial area is not completed (step S308 No), recording of the dummy data is executed to the unrecorded area (FIG. 8A: step S304). When the dummy data recording to the selected dummy data recording partial area is completed (step S308 Yes), searching of completion of dummy data recording processing to all dummy data recording partial areas which are generated by dividing a dummy data recording area into a plurality of areas is executed based on the data recording log (step S309).

When dummy data recording processing to all partial dummy data recording areas is not completed (step S310 No), next dummy data recording partial area is selected (FIG. 8A: step S311), and the dummy data writing processing is continued from step S302. When the dummy data writing processing to all partial dummy data recording areas is completed (step S310 Yes), the writing processing of the dummy data is completed. After that, returning to step S210 (FIG. 7A), and, returning to the condition waiting for a command from the host device after confirmation of completing update of the recording mode information in the RMZ.

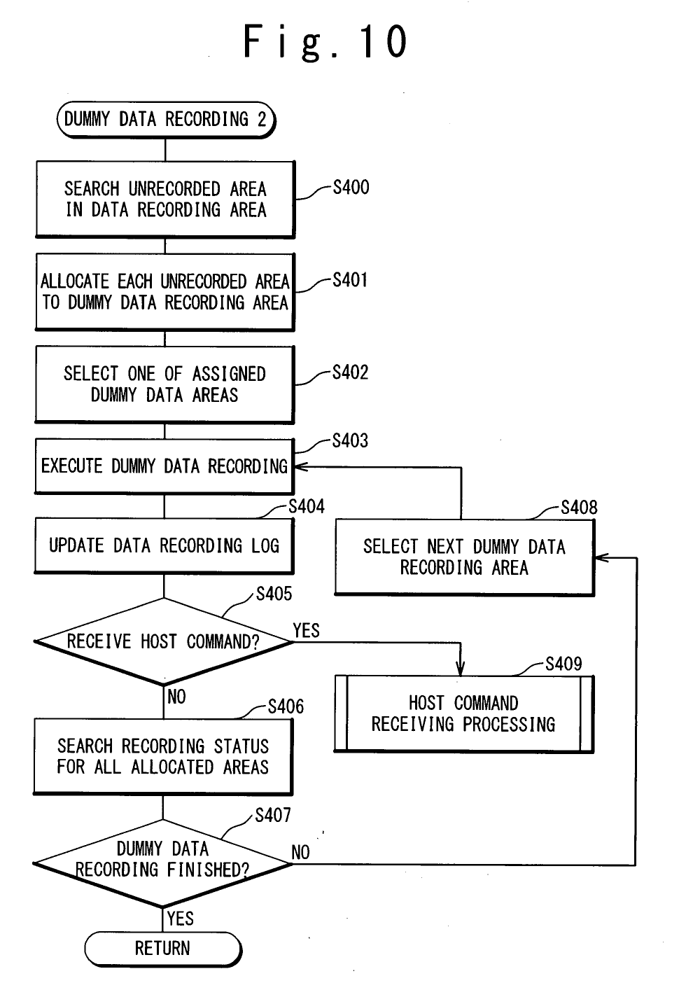

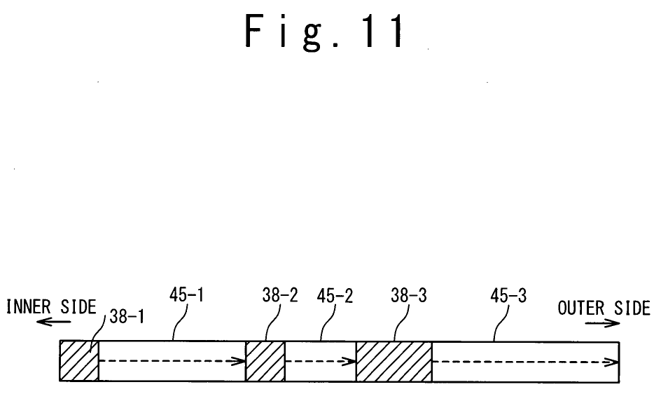

Next, referring to FIG. 10, an operation of a second dummy data recording processing will be described. In the second dummy data writing processing, there is a difference in the selecting dummy data recording area. As shown in FIG. 11, it is supposed that a recorded area 38-1, an unrecorded area 45-1, a recorded area 38-2, an unrecorded area 45-2, a recorded area 38-3, and an unrecorded area 45-3 randomly exist in a data area from its inner side. Disc management information of the optical disc 20 is recorded, and an area on an outer side whose frequency of being requested for recording from the host device is comparatively low is processed in first prior to the area on an inner side whose frequency of being requested for recording from the host device is comparatively high. Accordingly, the optical disc driving device 10 operates so that the dummy data recording processing can be executed in the order of the unrecorded area 45-3, the unrecorded area 45-2, and the unrecorded area 45-1. That is to say, when the optical disc driving device 10 records the dummy data to the unrecorded area on the optical disc 20, an unrecorded area in which normal data recording and dummy data recording are not executed in an area in which dummy data must be recorded is allocated to a dummy data recording area, and dummy data recording is executed. As described above, recording of dummy data can be efficiently executed on the optical disc 20 by selecting a dummy data recording area.

As shown in FIG. 10, the optical disc driving device 10 searches an unrecorded area to which data recording is not executed in an area on the optical disc 20 according to an indication of normal data recording from the host device (step S400).

The optical disc driving device 10 allocates the searched unrecorded areas (unrecorded areas 45-1 to 45-3 shown in FIG. 11, for example) to the dummy data recording areas (step S401). One area of these dummy data recording areas, for example, the unrecorded area 45-3 is selected (step S402). The optical disc driving device 10 records the dummy data into the selected dummy data recording area 45-3 (step S403). When dummy data recording to one unrecorded area is completed, the optical disc driving device 10 updates the data recording log in the RMZ showing a recording status of data on a disc (step S404). After that, it is confirmed whether a command is received from the host device or not (step S405).

When the command is received from the host device (step S405 Yes), host command reception processing starts (step S409). An operation of the host command reception processing will be described below. When the command is not received from the host device (step S405 No), searching of completion of dummy data recording processing to all areas allocated to the dummy data recording areas is executed (step S406).

When the dummy data recording processing to all areas allocated to the dummy data recording areas is not completed (step S407 No), the optical disc driving device 10 selects a next dummy data recording area (step S408). The optical disc driving device 10 continues the dummy data recording processing, returning to step S402. When the dummy data recording processing to all areas allocated to dummy data recording areas is completed (step S407 Yes), the dummy data recording processing is completed. After that, returning to step S210 (FIG. 7A), and, returning to a condition waiting for a command from the host device after confirmation of completing update of the recording mode information in the RMZ.

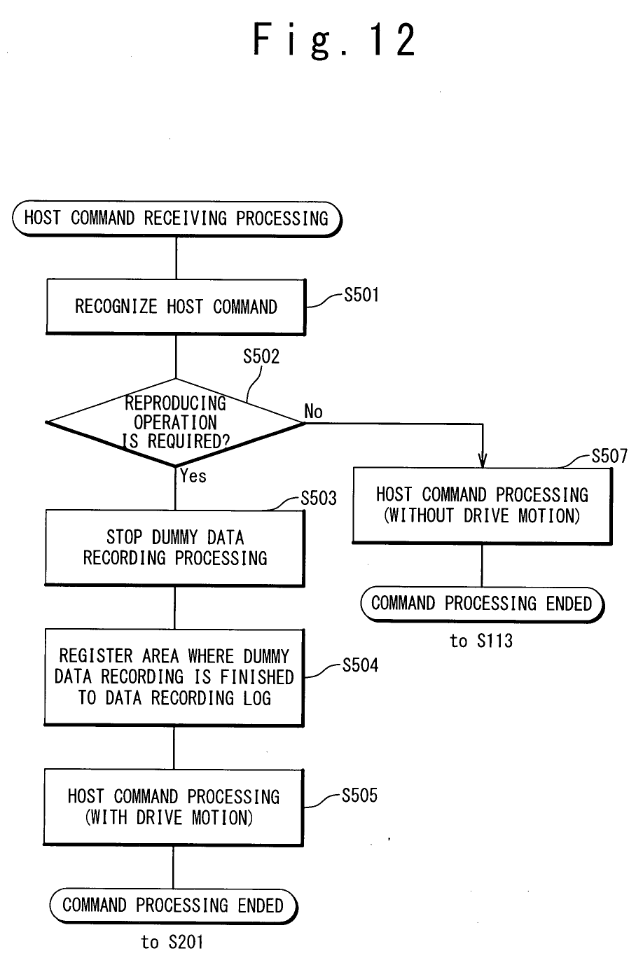

Next, referring to FIG. 12, an operation of host command reception processing will be described. FIG. 12 is a flowchart showing an example of an operation of the optical disc driving device 10 in a case where a command for requesting a normal recording and reproducing operation is issued from the host device during recording the dummy data into the dummy data recording area configured on the optical disc 20.

When a command issued by the host device is received, the optical disc driving device 10 identifies contents of the command (step S501). When the received command is a command which does not request a normal recording and reproducing operation (step S502 No), the optical disc driving device 10 executes the received command without stopping the dummy data recording processing (step S507). Being set in a condition waiting for a next command from the host device (step S113 in FIG. 7A).

When the received command is a command which requests a normal recording and reproducing operation (step S502 Yes), the optical disc driving device 10 temporarily stops the dummy data recording processing (step S503). The optical disc driving device 10 registers an area in which dummy data recording is completed until the dummy data recording is temporarily stopped to the data recording log in the RMZ showing a recording status of data on the optical disc 20 (step S504). After that, host command processing (step S505) is going to be executed, however, since this is an operation after step S201 (FIG. 7A), the recording and reproducing operation requested by the host device is executed.

The host command processing is executed as described above, and a loop of random recording mode processing shown in FIGS. 7A and 7B is repeated. A data recording status in the optical disc 20 is confirmed by the data recording log in the RMZ. When the unrecorded area exists on the optical disc 20, the dummy data recording operation is restated and the dummy data is progressively recorded in the unrecorded area. When the unrecorded area exists no more, compatibility with a ROM medium is secured to the optical disc 20.

As thus, the optical disc 20 of the present embodiment includes recording mode information and data recording log as the management information, and the optical disc driving device 10 automatically executes the dummy data recording processing for forming a recording mark in the unrecorded area in the random recording mode. As a result, it can be possible to divert the optical disc 20 of the random recording mode into the optical disc 20 securing compatibility with the ROM medium without making users aware of the mode.

### Second Embodiment

Next, a second embodiment of the present invention will be described. The optical disc driving device 10 according to a second embodiment supports only the sequential recording mode. Since a configuration of the optical disc driving device 10 is the same as a configuration of the optical disc driving device 10 according to a first embodiment, description is omitted.

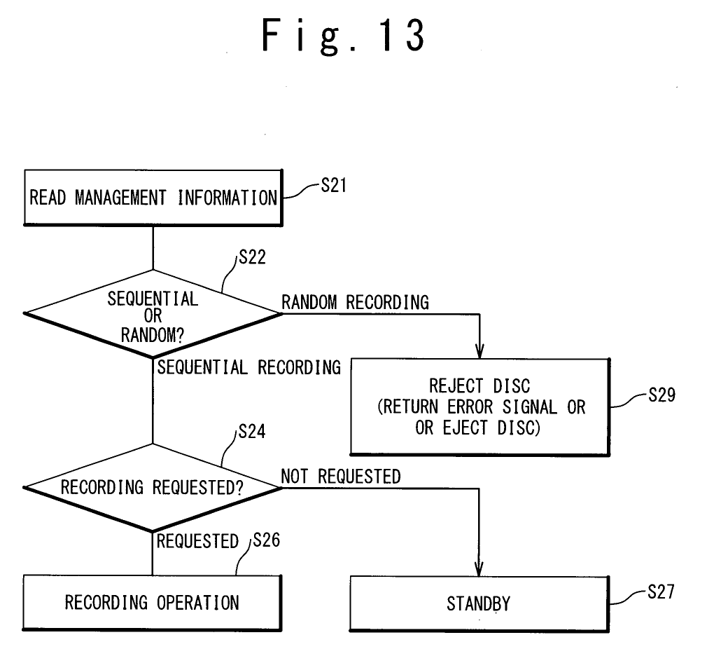

The optical disc driving device 10 supporting only the sequential recording mode operates as shown in FIG. 13 responding to an indication from the host device. The optical disc driving device 10 accesses an information management area of the loaded optical disc 20, and read the management information (step S21). The optical disc driving device 10 determines which recording mode does the optical disc 20 record data in based on the recording mode information in the management information (step S22).

When the optical disc 20 is recorded in the random recording mode (step S22 random recording), the optical disc driving device 10 cannot allow recording operation in the random recording mode since supporting only the sequential recording mode. As a result, the optical disc driving device 10 executes a recording refusal operation, such as returning error signal to an indication of the host device or ejecting the loaded optical disc 20, without executing recording even when the host device demands recording.

On the other hand, when the optical disc 20 is recorded in the sequential recording mode (step S22 sequential recording), the optical disc driving device 10, when the host device 10 demands recording (step S24 demanded), executes recording in accordance with the demand for recording (step S26). When there is no demand for recording (step S24 not demanded), the optical disc driving device 10 waits for an indication from the host device (step S27). Since the optical disc driving device 10 sequentially forms recording marks, there is no need to record unrecorded areas in idle time like an optical disc device for the random recording.

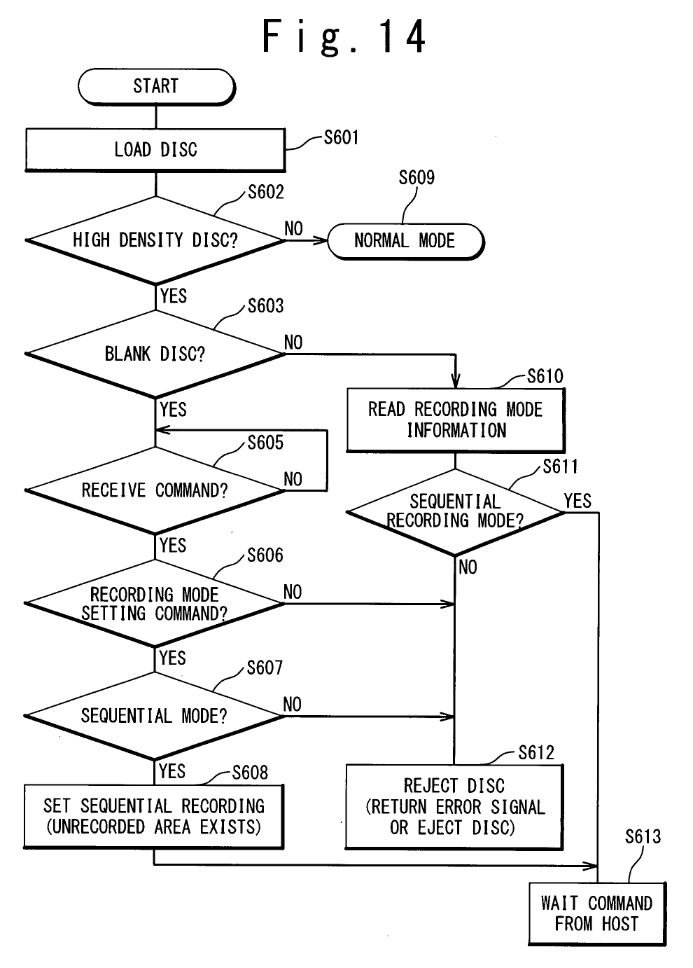

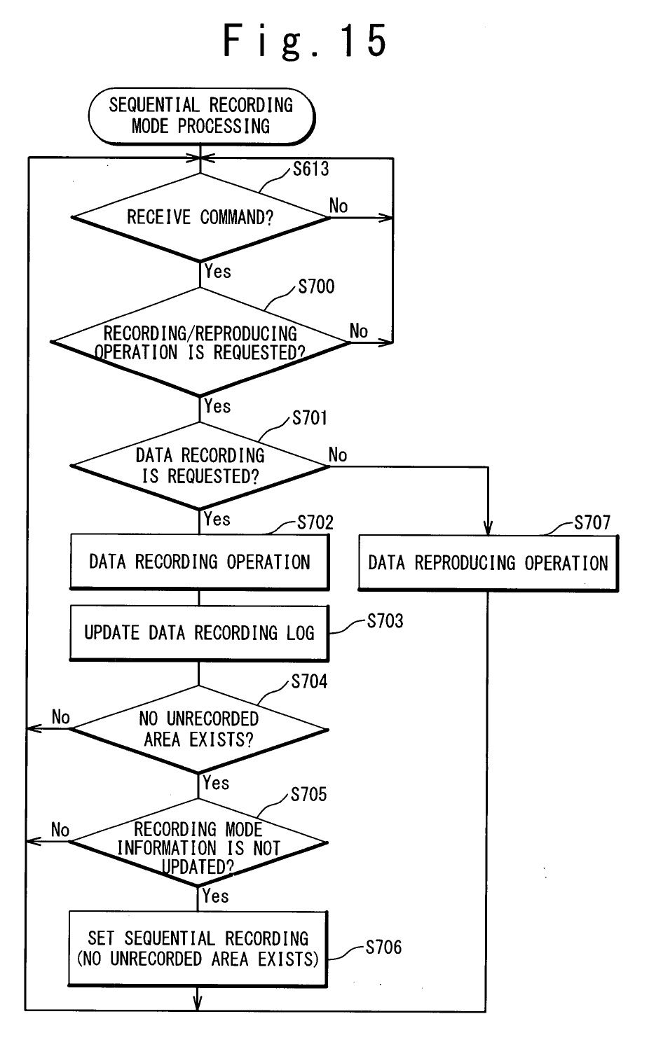

Further, referring to FIGS. 14 and 15, details of an operation of the optical disc driving device 10 will be described. FIG. 14 is a flow chart showing an operation when the optical disc 20 is loaded in the optical disc driving device 10.

When the optical disc 20 is loaded, the optical disc driving device 10 starts driving of the optical disc 20 according to a predetermined procedure including, for example, spindle on, laser on, and servo on. When the optical disc 20 is set to be accessible, the optical disc driving device 10 reads management information recorded in a system area. A sort of the optical disc and data recording status are specified based on a distance from an optical disc surface to a reflecting film, the number of the reflecting films, and other information recorded in the optical disc 20 (step S601).

When the optical disc 20 is not a high density optical disc (step S602 No), processing is progressed to a normal sequential recording operation without executing setting of a recording mode to the recording mode information in the RMZ (step S609).

When the loaded optical disc 20 is the high density optical disc (step S602 Yes), the optical disc driving device 10 confirms a recording status of data on the optical disc 20, whether the disc is a blank disc in which data is not recorded or not (step S603).

When the loaded optical disc 20 is not a blank disc (step S603 No), recording mode information configured in the RMZ is read, and the configured information is confirmed (step S610). When the sequential recording mode is not set in the recording mode information (step S611 No), error processing such as returning error signal to the host device and ejecting the disc is executed (step S612). When a set recording mode is the sequential recording mode (step S611 Yes), a command waiting condition for waiting indication from the host device is set (step S613).

When the loaded optical disc 20 is a blank disc (step S603 Yes), a command waiting condition for waiting indication from the host device is set (step S605).

When a command received from the host device is not a recording mode setting command for setting the recording mode (step S606 No), the optical disc driving device 10 executes the error processing such as returning error to the host device and ejecting the disc (step S612). When receiving the recording mode setting command from the host device (step S606 Yes), the optical disc driving device 10 confirms whether a recording mode required by the host device 10 is the sequential recording mode or not (step S607).

When the recording mode requested by the host device is not the sequential recording mode (step S607 No), the optical disc driving device 10 executes the error processing such as returning error signal to the host device and ejecting the disc (step S612). When setting of the sequential recording mode is requested by the host device (step S607 Yes), the “sequential recording mode (existence of unrecorded area)” is set and is recorded in the RMZ (step S608). After that, the optical disc driving device 10 is set to be in a condition waiting for a command from the host device (step S613).

An example of an operation after the command waiting condition (step S613) is shown in FIG. 15. The optical disc driving device 10 waits for indication from the host device in the sequential recording mode (step S613). When a command requesting a normal recording and reproducing operation is not received from the host device (step S700 No), a condition waiting for a command from the host device is continued.

When a command requesting the normal recording and reproducing operation is received (step S700 Yes) in the condition waiting for the command from the host device (step S613), contents of the received command are confirmed (step S701).

When the command from the host device is a command for requesting data reproduction (step S701 No), a normal data reproducing operation is executed to the optical disc 20 (step S707), returning to the condition waiting for the command from the host device (step S613). When the command from the host device is a command for requesting data recording (step S701 Yes), a data recording operation is executed to the optical disc 20 (step S702). When the data recording is completed, the data recording log in the RMZ showing a recording status of data on the optical disc 20 is updated (step S703).

After that, it is determined whether the unrecorded area exists on the optical disc 20 or not (step 704). When the unrecorded area exists on the optical disc 20 (step S704 No), returning to a condition waiting for the command from the host device (step S613). When the unrecorded area does not exist on the optical disc 20 (step S704 Yes), it is confirmed whether updating of the recording mode information in the RMZ is completed or not (step S705). When the recording mode information in the RMZ is updated (step S705 No), returning to the condition waiting for a command from the host device (step S613). When the recording mode information in the RMZ is not updated (step S705 Yes), the “sequential recording mode (no existence of unrecorded area)” is set to the recording mode information in the RMZ (step S706), and returning to the condition waiting for a command from the host device (step S613).

As thus, in a case of the optical disc driving device 10 for the sequential recording mode, there is no need to record the unrecorded areas in idle time like an optical disc device for random recording since recorded areas are sequentially formed. By executing final processing called finalizing, a compatibility with the ROM medium is secured.

As described above, an operation sequence of a case where the optical disc driving device 10 supports only the random recording mode is explained in a first embodiment and an operation sequence of a case where the optical disc driving device 10 supports only the sequential recording mode is explained in a second embodiment. An optical disc device supports both of the random recording mode and the sequential recording mode performs operations of the both recording modes. The optical disc device supporting the both modes does not refuse recording even when a disc of either recording mode is loaded. In addition, when the optical disc 20 in which the unrecorded area remains is loaded, the optical disc driving device 10 automatically records dummy data in the unrecorded area when not being commanded to execute recording, reproducing, and so on. The optical disc driving device 10, in accordance with an indication from the host device, operates in the indicated recording mode when the blank disc is loaded in the optical disc device. If the loaded optical disc 20 is already recorded in the random mode or the sequential recording mode, an operation just have to follow the recording mode actually recorded.

In addition, the present invention is not restricted to a wavelength 405 nm and NA 0.65, and various wavelengths and the number of openings NA can be applied to. In the description above mentioned, although a class called PR (12221) is used, other classes such as PR (1221) and the like can be also used. Furthermore, in the description above mentioned, although a case where a PRML is used is described, a system without the PRML can be also used.

It is apparent that the present invention is not limited to above embodiments, but may be modified and changed without departing from the scope and spirit of the invention.

What is claimed is:

1. An information recording medium comprising:
a data area which records user data; and
a system area which records management information to manage a recording status of the data area,
wherein the management information includes a recording mode information indicating a recording procedure of the user data stored in the data area.

2. The information recording medium according to claim 1, wherein the information recording medium is configured to store selectively either of sequential recording mode information indicating the recording procedure by which the user data is recorded in a continuous area or random recording mode information indicating the recording procedure by which the user data is recorded in a discretely allocated areas as the recording mode information.

3. The information recording medium according to claim 1, wherein the management information includes an area recording mark being recorded and an area recording mark being not recorded.

4. A recording method of an information recording medium comprising:
(a) reading out recording mode information from an information recording medium, wherein the recording mode information is set to the information recording medium and indicates a recording procedure of a user data storing in the information recording medium;
(b) judging whether a recording function corresponding to the recording procedure indicated by the recording mode information is available or not; and
(c) recording data to the information recording medium when the recording function is judged to be available in the (b) judging.

5. The recording method of the information recording medium according to claim 4, further comprising:
(c′) executing rejection operation indicating data recording to the information recording medium being not possible when the recording function is judged to be not available in the (b) judging.

6. A recording method of an information recording medium comprising:
(a) reading out recording mode information from an information recording medium, wherein the recording mode information is set to the information recording medium and indicates a recording procedure of a user data storing in the information recording medium;
(b) judging whether a recording function corresponding to the recording procedure indicated by the recording mode information is available or not; and
(c) executing rejection operation indicating data recording to the information recording medium being not possible when the recording function is judged to be not available in the (b) judging.

7. The recording method of the information recording medium according to claim 4, wherein the recording mode is selectively set to either of sequential recording mode information indicating the recording procedure by which the user data is recorded in a continuous area or random recording mode information indicating the recording procedure by which the user data is recorded in a discretely allocated areas as the recording mode information.

8. The recording method of the information recording medium according to claim 4, further comprising:
(d) recording automatically a predetermined recording mark on an unrecorded area a recording mark being not recorded.

9. The recording method of the information recording medium according to claim 8, wherein the (d) recording includes:
(d1) recording the predetermined recording mark from an outermost area of the unrecorded area in the information recording medium.

10. The recording method of the information recording medium according to claim 8, wherein the (d) recording includes:
(d2) managing the unrecorded area by dividing the unrecorded area per a predetermined size into a plurality of partial areas; and
(d3) recording the predetermined recording mark from an outer side area of the plurality of partial areas.

11. The recording method of the information recording medium according to claim 8, wherein the (d) recording includes:
(d4) recording the predetermined recording mark from an outermost side area of a plurality of unrecorded areas each of which is located between recorded areas a recording mark is being recorded.

12. An information recording and reproducing apparatus comprising:
a recording status information read unit configured to read recording mode information from an information recording medium, wherein the recording mode information shows a recording mode indicating a recording procedure of a user data to be recorded in the information recording medium and is set to the information recording medium; and
a processing determination unit configured to judge whether a recording function corresponding to the recording procedure indicated by the recording mode information is available or not,
wherein data recording on the information recording medium is performed only when the processing determination unit judges the recording function is available.

13. The information recording and reproducing apparatus according to claim 12, wherein the information recording and reproducing apparatus performs a rejection operation which shows data recording to the information recording medium is not possible when the processing determination unit judges the recording function is not available.

14. An information recording and reproducing apparatus comprising:
a recording status information read unit configured to read recording mode information from an information recording medium, wherein the recording mode information shows a recording mode indicating a recording procedure of a user data to be recorded in the information recording medium and is set to the information recording medium; and
a processing determination unit configured to judge whether a recording function corresponding to the recording procedure indicated by the recording mode information is available or not,
wherein the information recording and reproducing apparatus performs a rejection operation which shows data recording to the information recording medium is not possible when the processing determination unit judges the recording function is not available.

15. The information recording and reproducing apparatus according to claim 12, wherein the recording mode is selectively set to either of sequential recording mode information indicating the recording procedure by which the user data is recorded in a continuous area or random recording mode information indicating the recording procedure by which the user data is recorded in a discretely allocated areas as the recording mode information.

16. The information recording and reproducing apparatus according to claim 12, further comprising:
a dummy data recording process controlling unit configured to automatically record a predetermined recording mark in an unrecorded area a recording mark being not recorded.

17. The information recording and reproducing apparatus according to claim 16, wherein the dummy data recording process controlling unit records the predetermined recording mark in the unrecorded area from an area located in an outermost side of the information recording medium.

18. The information recording and reproducing apparatus according to claim 16, wherein the dummy data recording process controlling unit is configured to manage the unrecorded area by dividing the unrecorded area per a predetermined size into a plurality of partial areas, and to record the predetermined recording mark from an outer side area of the plurality of partial areas.

19. The information recording and reproducing apparatus according to claim 16, wherein the dummy data recording process controlling unit is configured to record the predetermined recording mark from an outermost side area of a plurality of unrecorded areas each of which is located between recorded areas a recording mark is being recorded.

20. The information recording and reproducing apparatus according to claim 16, wherein the dummy data recording process controlling unit automatically records the predetermined recording mark when the random recording mode is set as the recording mode information in the information recording medium.
